(19) United States
(12) Patent Application Publication
(10) Pub. No.: US 2006/0183462 A1
(43) Pub. Date: Aug. 17, 2006

(54) Managing an access account using personal area networks and credentials on a mobile device

(75) Inventor: Mikko Kolehmainen, Jarvenpaa (FI)

Correspondence Address: DARBY & DARBY P.C., P. O. BOX 5257, NEW YORK, NY, 10150-5257, US

(73) Assignee: Nokia Corporation, Espoo (FI)

(21) Appl. No.: 11/055,892

(22) Filed: Feb. 11, 2005

(51) Int. Cl. H04M 1/66; H04B 7/00

(52) U.S. Cl. 455/411; 455/410; 455/41.2

(57) ABSTRACT

A system, apparatus, and method are directed towards automatically managing an access account at an access point using near field communications and credentials stored on a mobile device. The mobile device receives, out-of-band, information for use in creating an account for accessing network resources from the access point. As the mobile device is brought into proximity with the access point, a wireless network connection is established using a near field communication (NFC) protocol. The information, which may include a user credential, account information, and so forth, is communicated to the access point. The access point employs the information to establish an account and create an environment from which access to the network resources may be obtained. Upon termination, the access point removes from itself any user specific data. The access point may provide also session related information useable in billing the user of the mobile device.

### FIELD OF THE INVENTION

The present invention relates generally to computing access, and more particularly, but not exclusively, to a system, apparatus, and method for managing an access account at an access point using near field communications and credentials stored on a mobile device.

### BACKGROUND OF THE INVENTION

As society becomes more mobile, there is an increased desire to be able to access network resources at a location other than one's home location. Remote access, however, often requires the user to provide a username/password pair, to enable access to the network resources. However, this approach, although well adopted, carries with it numerous issues, including the difficulty of remembering passwords, and that the passwords may be improperly obtained and used to gain unauthorized access. Moreover, many of the remote computing devices may not be configured to enable one to access the desired network resources. Thus, it is with respect to these considerations and others that the present invention has been made.

### BRIEF SUMMARY OF THE INVENTION

This summary of the invention section is intended to introduce the reader to aspects of the invention and is not a complete description of the invention. Particular aspects of the invention are pointed out in other sections herein below and the invention is set forth in the appended claims, which alone demarcate its scope.

The present invention is a directed to automatically managing an access account at an access point using near field communications and credentials stored on a mobile device. As the mobile device is brought into proximity with the access point, a wireless network connection is established using, such as near field communication (NFC) protocol, or similar personal area network (PAN). The access point employs provided information, potentially including a credential, to establish an account and create an environment from which access to the network resources may be obtained. Upon termination, the access point removes from itself any user specific data. The access point may also provide session related information useable in billing the user of the mobile device.

In accordance with one embodiment of the present invention, a system is directed to use managing access to a computing resource. The system includes a mobile device and another computing device that is configured to operate as an access point. The mobile device includes a data store that is configured to receive and to store an end-user credential. The mobile device also includes a PAN component, such as a near field communication (NFC) component, that is configured to enable the mobile device to establish a PAN communication link with the other computing device. The mobile device also includes a remote access manager. The remote access manager is configured to perform actions, including if a PAN communication link is established with the other computing device, automatically providing the end-user credential to the other computing device; if the mobile device is authenticated based, in part, on the end-user credential, enabling a login to a session with the other computing device; and receiving information from the other computing device that is associated with the session. The other computing device includes a PAN component, such as an NFC component, that is configured to, at least in part, detect a presence of the mobile device such that the PAN communication link is establishable, and a mobile device access manager component. The mobile device access manager component is also configured to perform actions. Such actions include, receiving the end-user credential from the mobile device; automatically creating an access account for use, in part, to establish the session for accessing the computing resource, if the mobile device is authenticated based, at least in part, on the received end-user credential; providing information associated with the session to the mobile device; and if the session is terminated, securely cleansing the other computing device of data associated with the session.

In another embodiment of the invention, a method is directed towards managing access to a computing resource over a network. The method monitors for a presence of a mobile device, and if the presence of the mobile device is detected, initiates a near field communications (NFC) network link to be established with the mobile device. The method further receives from the mobile device a credential for use in authentication, wherein the mobile device is configured to provide the credential automatically upon establishment of the NFC network link. If the mobile device is authenticated based, at least in part, on the received credential, the method automatically creates an account environment for use in accessing the computing resource. The method further enables access to the account environment, and if the mobile device logs out of the account environment, securely removing the account environment and information associated with an end-user of the mobile device.

In still another embodiment of the invention, a computer-readable medium that has computer-executable components is directed to managing access to a computing resource. The components include a transceiver, a processor, and memory. The transceiver is directed to receiving and sending information to another computing device, and is configured to employ a near field communications (NFC) network link. The processor is in communication with the transceiver, and the memory is in communication with the processor and stores data and machine instructions that cause the processor to perform a plurality of operations. The operations include monitoring for a presence of a mobile device, and if the presence of the mobile device is detected, initiating the NFC network link to be established with the mobile device; receiving over the NFC network link from the mobile device a credential for use in authentication, wherein the mobile device is configured to provide the credential automatically; determining whether the mobile device is authentic based, at least in part on the received credential, and if the mobile device is authentic, automatically creating an account environment for use in accessing the computing resource; enabling access to the account environment; logging information associated with traffic over the NFC network link; and if the mobile device logs out of the account environment, securely removing the account environment and information associated with the mobile device use of the NFC network link.

A more complete appreciation of the present invention and its improvements can be obtained by reference to the accompanying drawings, which are briefly summarized below, to the following detail description of presently preferred embodiments of the invention, and to the appended claims.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a mobile device that may be included in a system implementing the invention;

FIG. 3 shows one embodiment of a server device operating as an access point that may be included in a system implementing the invention;

FIG. 4 shows one embodiment of a signal flow diagram for use in managing an access account using near field communications; and

FIG. 5 illustrates a logical flow diagram generally showing one embodiment of a process for managing an access account to an access point using near field communications, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed towards a system, apparatus, and method for automatically managing an access account at an access point using near field communications and credentials stored on a mobile device. In one embodiment, the access point is a server. The mobile device may receive, out-of-band, information for use in creating an account that enables access to network resources from the access point. In one embodiment, the information includes the credential. However, the invention is not so limited, and the mobile device may receive the information, including the credential, using virtually any mechanism.

As the mobile device is brought into proximity with the access point, a wireless network connection is established using near field communication (NFC) protocol, or similar PAN communications protocol. The information, which may include a user credential, account information, and so forth, is communicated to the access point in a manner that does not require manual interactions from an end-user of the mobile device. The access point then automatically employs the information to establish an account and create an environment from which access to the network resources may be obtained. In one embodiment, the created environment is configured to operate in a secure manner to control the user's access to selected resources and restrict access to non-authorized resources. Such secured environment is sometimes known as a walled garden. For example, the created environment may operate as a web interface, shell, guardian application, and the like, that restricts the user to a set of pre-determined actions, web sites, resources, and the like. Upon logout from the established account, the access point may remove any remaining user specific data. The access point may further provide to the mobile device, and/or another device, session related information for use in billing an end-user.

Illustrative Operating Environment

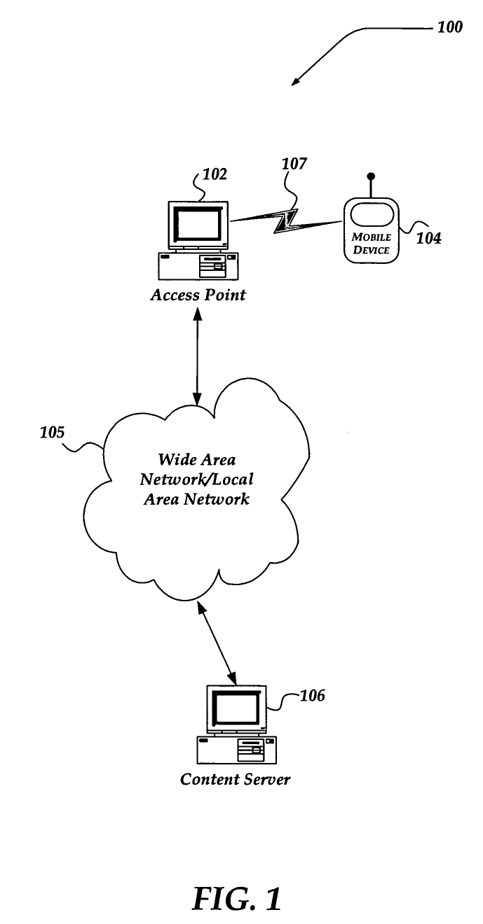

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes access point 102, network 105, wireless communications link 107, mobile device 104, and content server 106. Access point 102 is in communication with mobile device 104 through wireless communications link 107, and content server 106 through network 105.

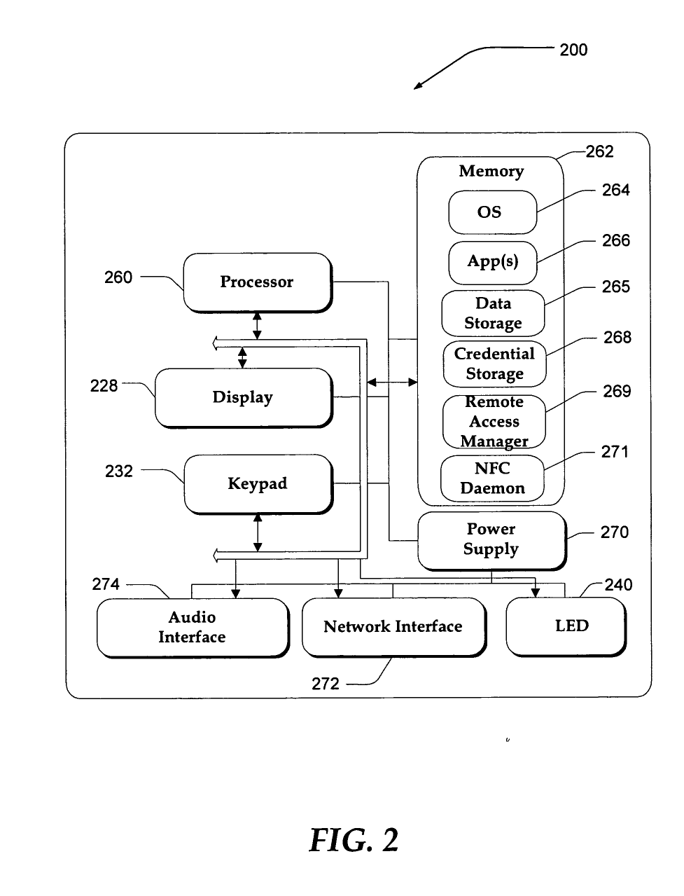

Mobile device 104 is described in more detail in conjunction with FIG. 2. Briefly, however, mobile device 104 may include virtually any computing client device capable of employing wireless communications link 107 to send and receive a message, to and from another computing device. The set of such devices may include devices that typically connect using a wireless communications medium such as cell phones, smart phones, pagers, walkie talkies, CBs, integrated devices combining one or more of the preceding devices, or virtually any mobile device, and the like. Similarly, mobile device 104 may be any device that is capable of connecting using a wired or wireless communication medium such as a personal digital assistant (PDA), POCKET PC, portable laptop devices, handheld computers, wearable computer, tablet computers, multiprocessor systems, microprocessor-based or programmable consumer electronics, and any other device that is equipped to communicate over a wired and/or wireless communication medium.

Mobile device 104 may include a browser application that is configured to receive and to send web pages, web-based messages, and the like. The browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), Wireless Markup Language (WML), EXtensible Markup Language (XML), various XML accents, WMLScript, JavaScript, and the like.

Mobile device 104 may be further configured to enable a user to further communicate with a network, such as network 105, to request a credential (described in more detail below) that enables mobile device 104 to be authenticated to access point 102. Mobile device 104 may receive the credential from access point 102, or another computing device, prior to establishing wireless communications link 107 with access point 102. In one embodiment, mobile device 104 may obtain the credential through an out-of-band mechanism. Mobile device 104 may also receive the credential from a third party, an end-user of mobile device 104, and the like. For example, the end-user may have a credential base ‘at a home resource,’ such as a home hub, a set-top-box, home personal computer, and the like. When the end-user of mobile device 104 prepares to relocate mobile device 104, the end-user could request from such home resource the credential. In one embodiment, the credential may be securely stored, accessed, and securely transferred between devices. Thus, out-of-band mechanisms for obtaining information for use with access point 102 includes virtually any out of an immediate process employed to also access the network resource on access point 102, content server 106, and the like. Mobile device 104 may further include one or more client applications that are configured to manage such actions on behalf of the client device.

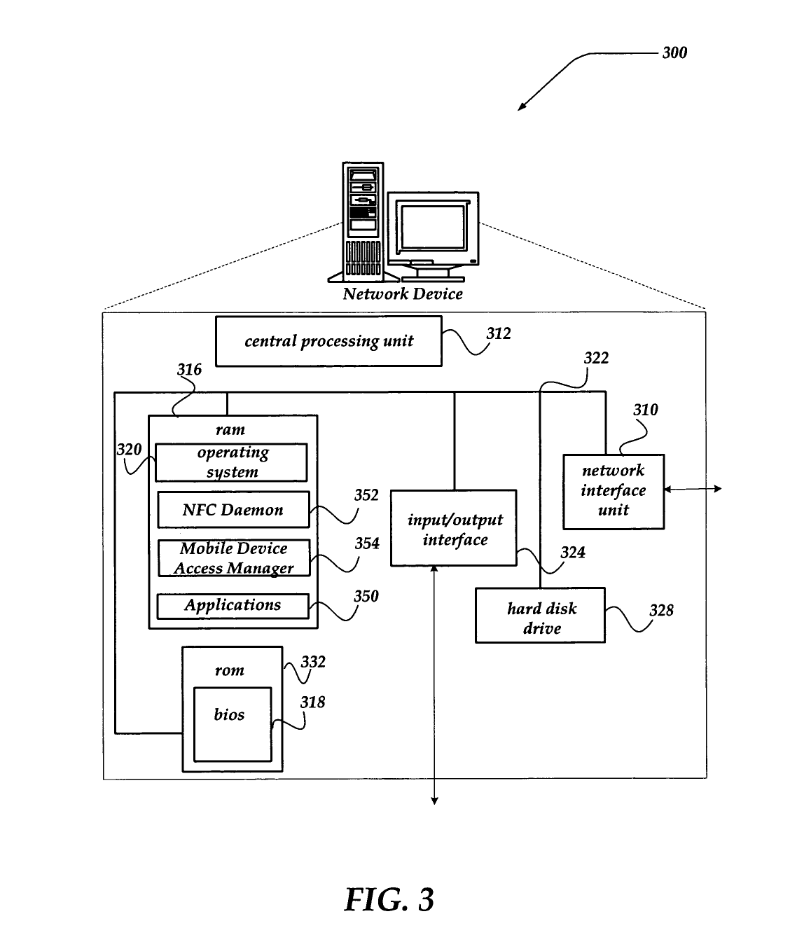

One embodiment of access point 102 is described in more detail below in conjunction with FIG. 3. Briefly, however, access point 102 may include virtually any computing device capable of establishing communication with mobile device 104 using wireless communications link 107, to enable mobile device 104 to access computing resources, including content server 106. Thus, access point 102 is further configured to connect to network 105 to enable mobile device to access content server 106. Devices that may operate as access point 102 include personal computers desktop computers, multiprocessor systems, microprocessor-based or programmable consumer electronics, network device, servers, and the like.

Moreover, access point 102 is configured to detect a presence of mobile device 104 and to establish wireless communications link 107 jointly with mobile device 104. Access point 102 may receive the credential from mobile device 104 over wireless communications link 107 and employ the credential to authenticate and enable access to mobile device 104. Access point 102 may be further configured to create an environment that allows mobile device 104 to communicate with content server 106. Use of access point 102's interface to access content server 106 is further directed at providing an improved end-user experience. Upon termination of the communication with content server 106, access point 102 may be configured to terminate wireless communications link 107, and to further securely delete any end-user specific data, configuration files, and the like, that may remain on access point 102. Although illustrated as a single device, the invention is not so constrained. Access point 102 may also comprise one or more components that are configured to distribute its functionality. For example, some of access point 102's functionality may also reside within content server 106, without departing from the scope or spirit of the invention. Wireless communications link 107 is configured to couple access point 102 and its components with another computing device, such as mobile device 104 using any of a variety of personal area network (PAN) wireless mechanisms. Typically, wireless communications link 107 is configured to provide temporary access to various network resources. In one embodiment, wireless communications link 107 employs the Near Field Communication Interface and Protocol (NFCIP), such as that which is described in more detail in such International Organization for Standardization/International Electrotechnical Commission (ISO/IEC) standards' documents as ECMA-340, “Near Field Communication—Interface and Protocol,” ISO/IEC 18092 (ISO/IEC JTC1 adopted ECMA-340 under its fast track procedure), ECMA-352 “Near Field Communication Interface and Protocol—2,” and the like, which are herein incorporated by reference. Such Near Field Communications (NFC) provides a mechanism to establish secure wireless communications between computing devices, such as access point 102 and mobile device 104. Although NFC is currently based on an inductive RF link configured to operate within about the 13.56 MHz range, and at operating distances between computing devices of up to about 20 cm., the invention is not so limited, and other PAN wireless communication link configurations may be employed without departing from the scope, or spirit of the invention. However, NFC need not be constrained to these values, and other predetermined operating distances, frequencies, and the like, may be employed. Although not required for the present invention, in one embodiment, once an NFC communication link is established, wireless communications link 107 may then be ‘switched’ to another PAN communication protocol, such as Bluetooth, Wi-Fi, and the like, for longer distance communication.

Network 105 is configured to couple content server 106 and its components with other computing devices, including, access point 102, and through wireless communications link 107 to mobile device 104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Network 105 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile device 104 with various degrees of mobility. For example, network 105 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. As such, network 105 may, for example, include a Home Location Register (HLR), profile service point, or similar component useable to provide and manage credentials. Furthermore, remote computers and other related electronic devices could be remotely connected to either LANs or WANs via a modem and temporary telephone link. In essence, network 105 includes any communication method by which information may travel between network devices.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Content server 106 may include any computing device that may include virtually content accessible over network 105. Content server 106 may include, for example, web pages, email, a database, FTP files, applications, media files, and the like, that mobile device 104 may seek to access. Devices that may operate as content server 106 include personal computers desktop computers, multiprocessor systems, microprocessor-based or programmable consumer electronics, network PCs, servers, and the like.

Illustrative Client Environment

FIG. 2 is a functional block diagram illustrating an embodiment of one embodiment of mobile device 200 for practicing the present invention. In one embodiment of the present invention mobile device 200 is implemented as mobile device 104 of FIG. 1.

Mobile device 200 may include many more components than those shown in FIG. 2. The components shown, however, are sufficient to disclose an illustrative embodiment for practicing the invention.

As shown in the figure, mobile device 200 includes processor 260, memory 262, display 228, and keypad 232. Memory 262 generally includes both volatile memory (e.g., RAM) and non-volatile memory (e.g., ROM, Flash Memory, or the like). Mobile device 200 includes operating system 264, which may be resident in memory 262 and configured to execute on processor 260. Keypad 232 may be a push button numeric dialing pad (such as on a typical telephone), a multi-key keyboard (such as a conventional keyboard), and the like. Display 228 may be a liquid crystal display, or any other type of display useable in mobile communications devices. For example, display 228 may be touch-sensitive, and may then also act as an input device enabling entry of stencil input, touch display, and so forth.

Mobile device 200 also may include power supply 270, which may be implemented as one or more batteries, solar devices, and the like. Power supply 270 might further include an external power source, such as an AC adapter or a powered docking cradle that supplements or recharges the batteries.

Mobile device 200 is also shown with two types of external notification mechanisms: LED 240 and audio interface 274. These devices may be directly coupled to power supply 270 so that when activated, they remain on for a duration dictated by the notification mechanism even though processor 260 and other components might shut down to conserve battery power. LED 240 may be programmed to remain on indefinitely until the user takes action to indicate the powered-on status of the device. Audio interface 274 may be used to provide audible signals to and receive audible signals from the user. For example, audio interface 274 may be coupled to a speaker for providing audible output and to a microphone for receiving audible input, such as to facilitate a telephone conversation.

Mobile device 200 also includes network interface 272 that performs the function of transmitting and receiving external communications. Network interface 272 facilitates, for example, wireless connectivity between mobile device 200, and the outside world, via a communications carrier or service provider. Transmissions to and from network interface 272 may be conducted under control of operating system 264. In other words, communications received by network interface 272 may be disseminated to application programs 266 via operating system 264, and vice versa. In one embodiment, network interface 272 employs NFC to initially establish a communication link with another computing device. Network interface 272 may then select to maintain use of the NFC protocol for the established session, or select another PAN communication mechanism, such as Wi-Fi, Bluetooth, and the like. Network interface 272 may further employ NFC daemon 271 to wake up other applications, such as remote access manager 269, to assist in establishing the NFC communication link with the other computing device.

Network interface 272 may allow mobile device 200 to communicate with other computing devices, such as over a network, using a variety of wired communications mechanisms. Network interface 272 is sometimes known as a transceiver or transceiving device. Network interface 272 is one example of a communication media.

Mobile device 200 includes credential storage 268 within memory 262. Credential storage 268 may be used to store information, which is intended to enable an end-user of mobile device 200 to access and become authenticated to another computing device. Credentials may include any of a variety of information, which may be needed by the other computing device to create an account for accessing the other computing device, and through it, another computing device, such as content server 106 of FIG. 1. Such information may include end-user account information, a password, s/key, a cost parameter such as a cost limit, a token such as an encrypted token, and the like. In one embodiment, the information may include a public key certificate. The specifics of the information, however, may depend on, for example, a service provider, owner, and the like, of the other computing device. Moreover, credential storage 268 may be secured employing any of a variety of mechanisms, including another password, a PIN code, a SIM authentication, another public key, biometrics, and the like.

Memory 262 may include one or more other storage components, such as data storage 265, that are configured to store information. Application programs 266 may use and store information in these other storage components, including data storage 265 and the like, including information such as e-mail or other messages used by an e-mail application, databases, and the like, documents used by a word processing application, and the like. Storage components, such as data storage 265, may further be available for receiving and managing billing and charging related data. In one embodiment, although not shown, mobile device 200 may further include one or more mass storage devices, such as hard disk drive, optical drive, removable storage component, and/or floppy disk drive. Such mass storage devices may also be employed to store one of more of the above-mentioned data, applications, and the like.

One or more application programs 266 may be loaded into memory 262 and run on the operating system 264. Examples of application programs include email programs, scheduling programs, Wireless Application Protocol (WAP) browsers, word processing programs, spreadsheet programs, and the like. However, the invention is not limited to these examples, and others may be employed. For example, a synchronization application may reside on mobile device 200 and be programmed to interact with a corresponding synchronization application resident on another computer to keep information stored in another storage component (not shown) synchronized with corresponding information stored at the other computer.

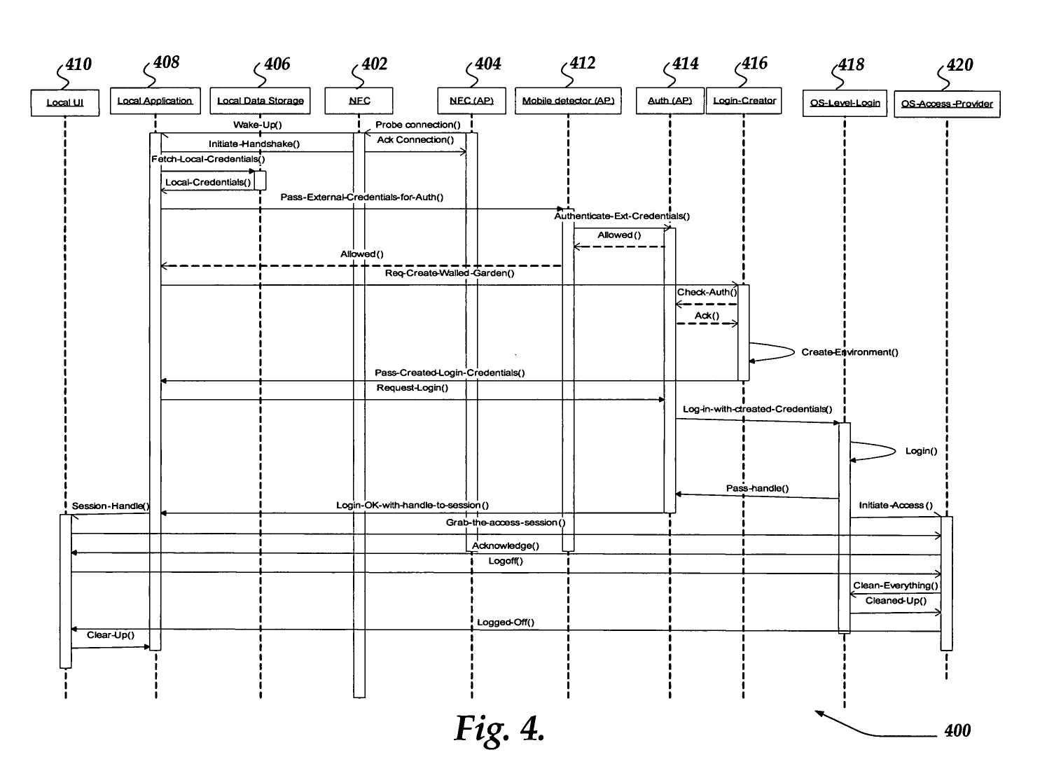

Memory 262 may also include remote access manager 269 which is configured to manage access to and communication with another computing device, such as access point 102 of FIG. 1 through a PAN mechanism, such as NFC. Remote access manager 269 may, for example, be alerted by NFC daemon 271 that a PAN connection has been established with another computing device and that authentication is requested. Remote access manager 269 may obtain an appropriate credential from credential storage 268 and provide it to the other computing device employing network interface 272. Upon authentication by the other computing device, remote access manager 269 may, in one embodiment, perform other actions, including, requesting an account environment be established at the other computing device, obtaining access to the account environment, and enabling the end-user to communicate messages, and other information, with the other computing device, and/or another computing device, such as content server 106 of FIG. 1. Remote access manager 269 may further be configured to manage billing information associated with the current session between the other computing devices, account creation, and the like. Remote access manager 269 may further ensure the clearance of data from the other computing devices when logging out of the other computing devices. In one embodiment, remote access manager 269 may include a user interface that enables the end-user to communicate with it, as well as the other computing devices. In one embodiment, remote access manager 269 may operate substantially as described below in conjunction with FIG. 4.

Illustrative Server Environment

FIG. 3 shows one embodiment of a network device that may be employed to operate as an access point, such as access point 102 of FIG. 1. Network device may be configured as a server, personal computer, network appliance, and the like. Network device 300 may include many more or less components than those shown. The components shown, however, are sufficient to disclose an illustrative embodiment for practicing the invention.

Network device 300 includes processing unit 312, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of server 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, such as network 105 in FIG. 1, via network interface unit 310, which is constructed for use with various communication protocols including the TCP/IP protocol. Network interface unit 310 may be configured further to determine a presence of another computing device that is capable of communicating using a PAN mechanism, including NFC, Wi-Fi, Bluetooth, and the like, and to enable such a communication link to be established. For example, network interface unit 310 may initially employ NFC to establish the communication link with the other computing device. Network interface unit 310 may then select to continue to employ the NFC protocol, or switch to another PAN communication mechanism. In one embodiment, network interface unit 310 employs NFC daemon 352 to perform such actions. Network interface unit 310 is sometimes known as a transceiver, transceiving device, network interface card (NIC), and the like.

Network device 300 may also include an SMTP handler application for transmitting and receiving email. Network device 300 may also include an HTTP handler application for receiving and handing HTTP requests, and an HTTPS handler application for handling secure connections. The HTTPS handler application may initiate communication with an external application in a secure fashion.

Network device 300 also includes input/output interface 324 for communicating with external devices, such as a mouse, keyboard, scanner, or other input devices not shown in FIG. 3. Likewise, network device 300 may further include additional mass storage facilities such as hard disk drive 328. Hard disk drive 328 is utilized by network device 300 to store, among other things, application programs, databases, and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs include email programs, schedulers, calendars, web services, transcoders, database programs, word processing programs, spreadsheet programs, and so forth. Further examples of application programs may include firewall applications, proxy applications, gateway applications, access point applications, and the like, that enable network device 300 to operate as a firewall, proxy server, gateway, network access point, and the like.

Mass storage may further include applications such as NFC daemon 352 and mobile device access manager (MDAM) 354. NFC daemon 352, described briefly above, enables network device 300 to communicate with network device 300 and/or mobile device 200 of FIG. 1 using NFC protocol, and to establish and maintain the NFC communication link, as appropriate, with the other computing device. MDAM 354 is configured to manage communications with the other computing device by monitoring for a presence of the other computing device within a vicinity sufficient to establish an NFC and/or other PAN communication link. MDAM 354 may further receive a credential from the other computing device, and enable authentication of the other computing device. MDAM 354 is not restricted, however, to merely employing the credential to determine authentication. For example, MDAM 354 may further employ additional information about the other computing device, as well as request additional information from the end-user of the other computing device.

MDAM 354 may further create an account including an environment, such as a “walled garden” environment, shell, and the like, to enable the authenticated computing device to access selected resources while inhibiting access to other resources. For example, MDAM 354 may employ a restricted menu, web page, script, restricted operating system shell, application, and the like, to enforce the walled garden. Such walled gardens may further vary based on different types of users, resources requested, services requested, cost related issues, and so forth. In one embodiment, a different walled garden may be employed based on a mobile device end-user's profile, information within a provided credential, and the like.

MDAM 354 may also enable the computing device to log into network device 300 at an operating system level. MDAM 354 may also monitor traffic between the other computing device and network device 300, and log information about such traffic, as well as requests, other actions, and the like, that may be determined to be relevant. When the end-user of the other device logs out of network device 300, MDAM 354 may further return any session related information to the other computing device including records that may be employed for charging and billing purposes. In one embodiment, MDAM 354 may further send charging and billing information to yet another computing device, such that the end-user may be billed based, at least in part, on the resources used.

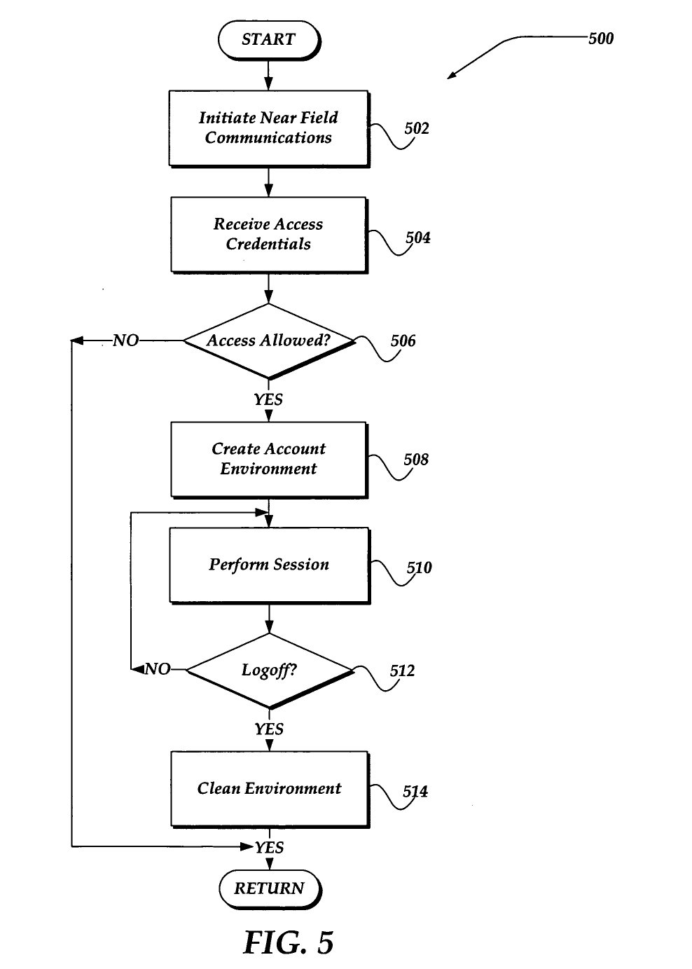

Moreover, MDAM 354 may clean network device 300 of any end-user specific data, environment, and the like. In one embodiment, the end-user specific data is cleared employing any of a variety of secured and guaranteed mechanisms. MDAM 354 may employ the processes described in FIGS. 4-5 to perform these actions.

Although MDAM 354 is described as a single component enabled to perform the above actions, the invention is not so limited. Thus, operations of MDAM 354 may be distributed across one or more distinct components. In one embodiment, for example, MDAM 354's operations may be distributed across a mobile detector component, an access authenticator component, a login-creator component, and the like. Moreover, the various components may be further distributed across one or more network devices without departing from the scope or spirit of the invention.

FIG. 4 shows one embodiment of a signal flow diagram for use in managing an access account using near field communications. Signal flow 400 may include many more or less components than those shown. The components shown, however, are sufficient to disclose an illustrative embodiment for practicing the invention.

As shown in the figure, signal flow 400 includes, across the top, local User Interface (UI) 410, local application 408, local data storage 406, NFC 402, NFC (AP) 404, mobile detector (AP) 412, authenticator (AP) 414, login-creator 416, OS-level-login 418, and OS-Access-Provider 420. Local User Interface (UI) 410, local application 408, local data storage 406, and NFC 402 are typically included within a mobile device, such as mobile device 104 of FIG. 1. Moreover, although illustrated as distinct components, local User Interface (UI) 410, and local application 408 may comprise a single component such as remote access manager 269 of FIG. 2, and operate in a substantially similar manner. In addition, local data storage 406 and NFC 402 may operate substantially similar to credential storage 268 and NFC daemon of FIG. 2, respectively.

Moreover, NFC (AP) 404, mobile detector (AP) 412, authenticator (AP) 414, login-creator 416, OS-level-login 418, and OS-Access-Provider 420 typically reside within one or more access point devices, such as access point 102 of FIG. 1. Although illustrated as distinct components, mobile detector (AP) 412, authenticator (AP) 414, and login-creator 416 may comprise a single component, such as MDAM 354 of FIG. 3, and operate in a substantially similar manner. Moreover, NFC (AP) may operate substantially similar to NFC daemon 352 of FIG. 3.

FIG. 4 illustrates a flow of messages, and/or signals, and related actions. Although, time may be considered to flow downwards in the figure, the invention is not so constrained. For example, several actions may occur at substantially the same time, without departing from the scope of spirit of the invention. However, for ease of illustration, the flows are separated. Moreover, not all of the flows are required by the invention, and others may be employed.

As described below, except perhaps, for the end-user bringing the mobile device in proximity with the access point, and initializing and/or invoking any dedication applications on the mobile device, the flow of messages are virtually automatic.

As shown, NFC (AP) 404 may monitor for a presence of a mobile device based on any of a variety of information, including receiving an NFC communication signal from the mobile device. NFC 402 may also send a wake-up message to local application 408 that may include information about the NFC communication link, the access point, and the like. Upon receiving the NFC wake-up message, a series of handshakes may occur between local application 408 and NFC 404 to establish the NFC communication link between the access point device and the mobile device. In one embodiment, the handshakes may be between NFC 402 and NFC (AP) 404.

Local application 408 requests and receives a credential from local data storage 406. Local application 408 may automatically provide the credential without an end-user interaction to mobile detector (AP) 412 using the NFC communication link. Mobile detector (AP) 412 may then proceed to provide the credential to Authenticator (AP) 414 for authentication of the mobile device. If the mobile device is authenticated, as shown, a message to that affect is forwarded to local application 408. In the event that the mobile device is not authenticated, any of a variety of pre-determined actions (not shown) may result. For example, NFC (AP) 404 may be instructed to terminate the communication link with the mobile device, a message may be sent to the mobile device indicating that the mobile device is not authenticated, another request for authentication may be made, and the like.

In any event, if the mobile device is authenticated and allowed access, a request may be provided by local application 408 for the automatic creation of a walled garden, shell, and the like. Although illustrated as a request from local application 408, the invention is not so limited, and login-creator 416 may also automatically create a secure account and associated environment based only on receiving information indicating that the mobile device is authenticated from authenticator (AP) 414. Upon acknowledgement that the mobile device is authenticated, login-creator 416 may create a secured environment, such as a walled garden, and the like, to enable the mobile device access to a restricted set of resources. In one embodiment, login-creator 416 may employ operating system root account access rights, and strong security measures.

In one embodiment, as shown in the figure, login-creator 416 may provide a set of created login-credentials that enable the mobile device to then request a login to the created environment including a temporary account. In one embodiment, this may include an ability to login at an operating system level using OS-level login 418. The mobile device may then be enabled, to allow its end-user, through local UI 410 to perform session related activities, including requesting a resource, receiving a response, and so forth. During the session, although not shown, one of more components within the access point, such as OS-Access provider 420, NFC (AP) 404, or the like, may monitor network traffic and log session related information.

The end-user, using local UI 410 may request a logoff of the resource, of the access point, and the like. Upon receiving the logoff, OS Access Provider 420 may provide a request to OS-level-login 418 to cleanse the access point, resource, and the like, of end-user data, including the account, credential, files, and the like. Cleansing may include deleting or otherwise erasing any end-user data employing a secure mechanism that is directed towards minimizing an ability to subsequently retrieve the cleansed information. In one embodiment, (not shown) prior to cleansing the devices of the end-user data, OS-access provider 420, and/or a component of the access point device may provide billing information to the mobile device. In another embodiment, local application 408 may also be instructed to perform clean-up on the mobile device of session related data.

FIG. 5 illustrates a logical flow diagram generally showing one embodiment of a process for managing an access account to an access point using near field communications, in accordance with the present invention. Process 500 may be implemented, for example, within MDAM 354 of FIG. 3. Briefly, process 500 typically commences when an end-user of a mobile device, such as mobile device 104 of FIG. 1, brings the mobile device within sufficient proximity of an access point that is enabled to establish a PAN communications link, such as an NFC communications link. The access point may represent, for example, an access point to an Internet cafe, a friend's computing device, and the like. Moreover, typically, the end-user does not have an existing account within the access point.

Process 500 begins, after a start block, at block 502, where a near field communications link is initiated with a mobile device. Such initiation may include detection of a presence of the mobile device, and an NFC handshake protocol. Upon establishing the NFC communications link, the NFC communication link may be employed throughout a session with the mobile device. Alternatively, the communication link may be reconfigured to employ another PAN communications mechanism, including Wi-Fi, Bluetooth, and the like.

Processing flows next to block 504, where a credential is automatically received from the mobile device without manual interaction by the end-user of the mobile device. Moreover, the credential may be transferred from the mobile device over the established NFC communications link. As described above, the credential may include a password, account information, public key certificate, cost limits, a single key challenge-response such as s/key, and the like. In addition, the credential may include information associated with a resource that access is sought. In one embodiment, the mobile device may have received the credential through a prior communication with the present service, server, and the like.

Process 500 continues to decision block 506, where a determination is made whether access is to be allowed to the mobile device. Access may be allowed based on if the mobile device can be sufficiently authenticated using, at least in part, the received credential. If the mobile device is to be allowed access, processing flows to block 508; otherwise, processing returns to a calling process to perform other actions. Such other actions may include, for example, providing a message to the mobile device indicating that the mobile device is not authenticated, therefore access is denied; enabling the mobile device to retry authentication; terminating the NFC communication link; and the like.

At block 508, an account environment is created for use by the end-user of the mobile device. The account creation may be performed automatically and without the end-user's manual intervention. In one embodiment, the account environment is arranged employing scripts, web-pages, applications, menus, and the like, that create a secured environment to restrict access by the end-user of the mobile device to non-authorized resources. Processing continues next to block 510, where the end-user employs the account environment to perform session related activities, including requesting a resource, receiving a response to the request, and so forth. Such activities may further include requesting a resource from another computing device, such as a content server, sending an email message, and the like. In one embodiment, information associated with session activities, including resource requests, file transfers, session duration, resources used during the session, network transfers, and so forth may be tracked and logged.

Processing flows next to decision block 512, where a determination is made whether the end-user of the mobile devices indicates intent to log-off. If there is no indication, processing loops back to block 510, until an indication is received, upon which processing continues to block 514. Although not illustrated, in one embodiment, process 500 may also include an exit, if the communications is considered to be idle, a time-out case has arisen, and the like.

At block 514, at least some of the logged information, as well as a summary of such logged information, may be provided to the mobile device, and/or another computing device. In one embodiment, the logged information and/or summary information may be employed to determine a charge for access to the used resources by the mobile device. Furthermore, upon terminating the session, (logging out of the session), end-user data may be removed from the access point device. However, the invention is not limited cleansing the access point upon logging out of the session. For example, in one embodiment, cleansing of the system may be performed upon termination of the NFC communication, or PAN communication, and the like. In this manner, a clean and secure environment may be maintained on the access point device. Such cleansing is directed toward minimizing an ability to restore the cleansed information, and to minimize likelihood of any malware remaining on the system. In one embodiment, however, information may also be sent to the end-user of the mobile device, indicating what, if any, data, files, and the like, associated with the end-user may have remained on the access point device, when the end-user terminated the session. In any event, process 500 then returns to the calling process to perform other actions.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A system for use in managing access to a computing resource, comprising:
(a) a mobile device that comprises:
a data store that is configured to receive and to store an end-user credential;
a personal area network (PAN) component that is configured to enable the mobile device to establish a PAN communication link with another computing device;
a remote access manager coupled to the data store and PAN component that is configured to perform actions, including:
if a PAN communication link is established with the other computing device, automatically providing the end-user credential to the other computing device;
if the mobile device is authenticated based, in part, on the end-user credential, enabling a login to a session with the other computing device; and
receiving information from the other computing device that is associated with the session; and
(b) the other computing device configured to operate as an access point and comprises:
a PAN component that is configured to, at least in part, detect a presence of the mobile device such that the PAN communication link is establishable;
a mobile device access manager component that is coupled to the PAN component and is configured to perform actions, including:
receiving the end-user credential from the mobile device;
if the mobile device is authenticated based, at least in part, on the received end-user credential, automatically creating an access account for use, in part, to establish the session for accessing the computing resource;
providing information associated with the session to the mobile device; and
if the session is terminated, securely cleansing the other computing device of data associated with the session.

2. The system of claim 1, wherein the end-user credential further comprises at least one of an end-user account information, a password, s/key, a cost parameter, public key certificate, and a token.

3. The system of claim 1, wherein the remote access manager is configured to perform further actions, including:
receiving the end-user credential using an out-of-band mechanism; and
storing the end-user credential in the data store.

4. The system of claim 1, wherein establishing the PAN communication link further comprises employing a handshake protocol.

5. The system of claim 1, wherein detecting the mobile device further comprises detecting a near field communications (NFC) communications signal, wherein the mobile device and other computing device are within a predetermined distance from each other.

6. The system of claim 1, wherein automatically creating an access account further comprises creating a secured environment that is configured to enable access to a predetermined resource while inhibiting access to another resource.

7. The system of claim 6, wherein the secured environment further comprises at least one of a shell, a restricted menu, a restricted web page, a script, a restricted operating system shell, and a secure application.

8. The system of claim 1, wherein terminating the session further comprises terminating the communication link between the mobile device and the other computing device.

9. The system of claim 1, wherein enabling a login to a session further comprises:
receiving a login credential from the other computing device; and
requesting login to the other computing device, using at least in part, the created login credential, wherein the login credential enables the other computing device to provide an operating system level login access.

10. The system of claim 1, wherein the PAN communication link is replaceable with another link selected from at least one of a near field communications (NFC), a Wi-Fi, and a Bluetooth link, without losing communications between the mobile device and the other computing device.

11. The system of claim 1, wherein providing information associated with the session further comprises providing information for use in billing for use of at least one aspect of the session.

12. The system of claim 1, wherein automatically providing the end-user credential further comprises providing the end-user credential over the PAN communications link.

13. The system of claim 1, wherein providing information associated with the session further comprises monitoring network traffic between the mobile device and the other computing device to determine, at least in part, a portion of the information associated with the session.

14. A server device for use in managing access to a computing resource, the components comprising:
a transceiver for receiving and sending information to another computing device, the transceiver configured to employ a near field communications (NFC) network link;
a processor in communication with the transceiver; and
a memory in communication with the processor and for use in storing data and machine instructions that causes the processor to perform a plurality of operations, including:
monitoring for a presence of a mobile device, and if the presence of the mobile device is detected, initiating the NFC network link to be established with the mobile device;
receiving over the NFC network link from the mobile device a credential for use in authentication, wherein the mobile device is configured to provide the mobile device automatically;
determining whether the mobile device is authentic based, at least in part on the received credential, and if the mobile device is authentic, automatically creating an account environment for use in accessing the computing resource;
enabling access to the account environment;
logging information associated with traffic over the NFC network link; and
if the mobile device logs out of the account environment, securely removing the account environment and information associated with the mobile device use of the NFC network link.

15. A method of managing access to a computing resource over a network, comprising:
monitoring for a presence of a mobile device, and if the presence of the mobile device is detected, initiating a near field communications (NFC) network link to be established with the mobile device;
receiving from the mobile device a credential for use in authentication, wherein the mobile device is configured to provide the mobile device credential automatically upon establishment of the NFC network link;
if the mobile device is authenticated based, at least in part, on the received credential, automatically creating an account environment for use in accessing the computing resource;
enabling access to the account environment; and
if the mobile device logs out of the account environment, securely removing the account environment and information associated with an end-user of the mobile device.

16. The method of claim 15, wherein creating the account environment further comprises creating a walled environment that is configured to enable access to a predetermined resource while inhibiting access to another resource.

17. The method of claim 15, wherein the mobile device received and stored the credential using an out-of-band mechanism.

18. The method of claim 15, further comprising:
monitoring network traffic with the mobile device;
logging information associated with network traffic; and
providing at least a portion of the logged information to the mobile device, wherein at least the portion of the logged information is useable for a billing purpose.

19. A computer-readable medium having computer-executable components for use in managing access to a computing resource, the components comprising:
a transceiver for receiving and sending information to another computing device, the transceiver configured to employ a near field communications (NFC) network link;
a processor in communication with the transceiver; and
a memory in communication with the processor and for use in storing data and machine instructions that cause the processor to perform a plurality of operations, including:
monitoring for a presence of a mobile device, and if the presence of the mobile device is detected, initiating the NFC network link to be established with the mobile device;
receiving over the NFC network link from the mobile device a credential for use in authentication, wherein the mobile device is configured to provide the mobile device automatically;
determining whether the mobile device is authentic based, at least in part on the received credential, and if the mobile device is authentic, automatically creating an account environment for use in accessing the computing resource;
enabling access to the account environment;
logging information associated with traffic over the NFC network link; and
if the mobile device logs out of the account environment, securely removing the account environment and information associated with the mobile device use of the NFC network link.

20. The computer-readable medium of claim 19, wherein at least some of the logged information is provided to the mobile device and is useable to determine a usage charge.

21. A mobile device for use in accessing a resource, comprising:
a display;
a transceiver for receiving and sending information to another computing device;
a processor in communication with the display and the transceiver; and
a memory in communication with the processor and for use in storing data and machine instructions that causes the processor to perform a plurality of operations, including:
establishing a near field communications (NFC) network link with an access point;
automatically providing a stored end-user credential to the access point;
if the mobile device receives a message indicating that it is authenticated based, in part, on the provided end-user credential, performing actions to enable a login to a session with the access point, wherein the access point created an access account for use during the session, and wherein the access account includes a secure walled environment that is configured to enable access to a predetermined resource while inhibiting access to another resource; and
receiving information from the access point associated with network traffic between the mobile device and the access point, wherein at least a portion of the information is useable for a billing purpose.
